(19) United States
(12) Patent Application Publication
(10) Pub. No.: US 2026/0227949 A1
(43) Pub. Date: Aug. 6, 2026

(54) METHOD OF CONTROLLING COMMUNICATION BEING PERFORMED IN DISPLAY APPARATUS

(71) Applicant: LX Semicon Co., Ltd., Daejeon (KR)

(72) Inventor: You Jin KWON, Daejeon (KR)

(73) Assignee: LX Semicon Co., Ltd., Daejeon (KR)

(21) Appl. No.: 19/529,909

(22) Filed: Feb. 4, 2026

(30) Foreign Application Priority Data
Feb. 5, 2025 (KR) 10-2025-0014803

(51) Int. Cl. G06F 3/147

(52) U.S. Cl. CPC G06F 3/147

(57) ABSTRACT

A method of controlling communication being performed in a display apparatus according to an embodiment of the present disclosure includes transmitting, by a first module in a first substrate, a packet related to panel compensation data to a second module in a second substrate, transmitting, by the second module in the second substrate, the packet related to the panel compensation data to a memory in the second substrate only when it is determined that the packet is valid by referring to a specific field included in the packet related to the panel compensation data, in a write mode, receiving, by the first module in the first substrate, at least one done command from the memory via the second module in the second substrate, and in a read mode, receiving, by the first module in the first substrate, the panel compensation data stored in the memory via the second module in the second substrate and correcting image data on the basis of the received panel compensation data.

### CROSS-REFERENCE TO RELATED APPLICATIONS

This application claims the benefit of the Korean Patent Applications No. 10-2025-0014803 filed on Feb. 5, 2025, which is hereby incorporated by reference as if fully set forth herein.

### BACKGROUND

### Field of the Invention

Embodiments of the present disclosure relate directly or indirectly to a technology for controlling communication being performed in a display apparatus. For example, V-by-One (Vx1) or the like may be used, but the scope of the present disclosure is not limited thereto.

### Discussion of the Related Art

Organic light-emitting diode (OLED) displays are self-emissive displays that emit light without a separate light source. Unlike a local dimming technology for liquid-crystal displays (LCDs), a pixel dimming technology in OLEDs has an advantage of showing perfect image quality without light leakage because the brightness of each of pixels can be independently controlled.

OLEDs, which emit light by themselves, do not require components such as backlights, liquid crystals, color filters, etc., and have an advantage of having a simple structure to be thin and lightweight while providing clear image quality.

Further, OLEDs provide the following four technical effects.

First, OLEDs'high contrast ratio allows for deeper, more detailed rendering of the brightest white and black. Bright areas become brighter, dark areas darker, and darkness and light are rendered with exquisite detail and precision.

Second, OLEDs do not require a flicker-inducing driving method, which can cause eye fatigue and emit harmful light that is less than half that of LCDs, and thus allow users to enjoy content comfortably on their eyes for a long time.

Third, OLEDs may express detailed colors because they do not require backlights or other structural elements that lower the purity of light. The OLEDs vividly express all the colors of nature without distortion or loss.

Fourth, OLEDs do not require parts such as backlights and the like that use a lot of plastic, and thus the OLED displays are eco-friendly displays with only 10% plastic content and a recycling rate of up to 90% as compared to LCDs.

However, according to a related art, in display apparatuses such as OLED displays and the like, panel compensation data was stored in a control-printed circuit board (C-PCB).

In addition, there was a problem that when a problem occurs in a C-PCB or a problem occurs in a display panel itself other than the C-PCB, information on the display panel is stored in an embedded multimedia card (eMMC) or NAND memory, which is a storage medium in the C-PCB, and thus the C-PCB or the display panel alone could not be replaced and the entire display panel should be replaced together with the C-PCB.

### SUMMARY

An embodiment of the present disclosure aims to store panel compensation data in a specific board in a display apparatus.

Another embodiment of the present disclosure aims to store panel compensation data in a source-printed circuit board (S-PCB) in a display apparatus and to resolve various problems that occur during a communication process between the S-PCB and a control-printed circuit board (C-PCB).

In addition, still another embodiment of the present disclosure aims to define communication being performed in a display apparatus capable of transmitting/receiving data to/from a non-volatile memory over a long distance, rather than a chip-to-chip method.

A method of controlling communication being performed in a display apparatus according to an embodiment of the present disclosure to address the above-described technical objects includes transmitting, by a first module in a first substrate, a packet related to panel compensation data to a second module in a second substrate, transmitting, by the second module in the second substrate, the packet related to the panel compensation data to a memory in the second substrate only when it is determined that the packet is valid by referring to a specific field included in the packet related to the panel compensation data, in a write mode, receiving, by the first module in the first substrate, at least one done command from the memory via the second module in the second substrate, and in a read mode, receiving, by the first module in the first substrate, the panel compensation data stored in the memory via the second module in the second substrate and correcting image data on the basis of the received panel compensation data.

The packet related to the panel compensation data may include a first field for synchronizing a packet start point when data is transmitted and defining attribute information of data to be transmitted, a second field for defining address and length information of the data to be transmitted, a third field for defining actual data included in the packet, and a fourth field that is used for validity verification of the packet. In particular, the specific field may correspond to the fourth field.

The transmitting of, by the second module in the second substrate, the packet related to the panel compensation data to the memory in the second substrate only when it is determined that the packet is valid by referring to the specific field included in the packet related to the panel compensation data may further include transmitting, by the second module, a shadow done command to the first module simultaneously with the transmitting of the packet related to the panel compensation data to the memory in the second substrate.

The method of controlling communication being performed in the display apparatus according to an embodiment of the present disclosure may further include transmitting, by the first module that receives the shadow done command, another packet related to the panel compensation data to the second module.

The memory may correspond to, for example, a NAND flash memory or an embedded multimedia card (eMMC).

Furthermore, the first substrate and the second substrate may be connected by a first type flexible flat cable (FFC), and the second substrate and another second substrate may be connected by a second type FFC.

In addition, a display apparatus according to an embodiment of the present disclosure includes a first module in a first substrate that generates a packet related to panel compensation data and transmits the generated packet, and a second module in a second substrate that receives the packet related to the panel compensation data, then decodes the received packet, and transmits the packet related to the panel compensation data to a memory only when it is determined that the packet is valid by referring to a specific field included in the packet.

In a write mode, the first module in the first substrate may receive at least one done command from the memory via the second module in the second substrate.

On the other hand, in a read mode, the first module in the first substrate may be designed to receive the panel compensation data stored in the memory via the second module in the second substrate and to correct image data on the basis of the received panel compensation data.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 illustrates a display apparatus according to a related art;

FIG. 2 illustrates a display apparatus according to an embodiment of the present disclosure;

FIG. 3 illustrates a display apparatus according to another embodiment of the present disclosure;

FIG. 4 illustrates a communication protocol between a first module in a first substrate and a second module in a second substrate illustrated in FIG. 3 in more detail;

FIG. 5 illustrates an example of a data packet used during a communication process between the first module and the second module illustrated in FIG. 4;

FIG. 6 shows diagrams for describing timing when the data packet illustrated in FIG. 5 is used;

FIG. 7 schematically illustrates a write mode and read mode of a display apparatus according to an embodiment of the present disclosure;

FIG. 8 is a flowchart illustrating the write mode illustrated in FIG. 7 in more detail;

FIG. 9 is a flowchart for further improving a processing speed in the write mode illustrated in FIG. 8;

FIG. 10 is a flowchart of a processing process when there is a problem in cyclic redundancy check (CRC) information in the write mode illustrated in FIG. 9;

FIG. 11 illustrates two embodiments of a control-printed circuit board (C-PCB) and a source-printed circuit board (S-PCB) which are included in a display apparatus according to an embodiment of the present disclosure; and

FIG. 12 illustrates an embodiment different from the embodiments illustrated in FIG. 11.

### DETAILED DESCRIPTION OF THE DISCLOSURE

Throughout this specification, identical reference numbers refer to substantially identical components. In the following description, cases not related to the key components of the present disclosure and detailed descriptions of configurations and functions those known in the art may be omitted.

Advantages and features of the present disclosure and methods of achieving the same will be clearly understood with reference to the accompanying drawings and embodiments which will be described in detail below. However, the present disclosure is not limited to embodiments to be disclosed below but may be implemented in various different forms. The embodiments are provided in order to fully explain the present embodiments and fully explain the scope of the present disclosure for those skilled in the art. The scope of the present disclosure is only defined by the appended claims.

The shapes, sizes, ratios, angles, numbers, etc., disclosed in the drawings for describing the embodiments of the present disclosure are only exemplary, and therefore the present disclosure is not limited to the details illustrated. Like reference numerals refer to like components throughout the specification. Further, in descriptions of the present disclosure, when it is determined that detailed descriptions of related known configurations or functions are deemed to unnecessarily obscure the gist of the present disclosure, they will be omitted.

When the terms “comprise,” “include,” “have,” and “consist of” described in this specification are used, other parts may be added unless “only” is used. A component expressed in singular encompasses the expression in plural unless otherwise explicitly stated.

When interpreting components, it is interpreted as including an error range even when there is no separate explicit description.

When describing a positional relationship, for example, when a positional relationship between two parts is described as “on top of,” “upper part of,” “lower part of,” “next to,” etc., one or more other parts may be located between the two parts, unless “immediately” or “directly” is used.

When describing a temporal relationship, for example, when a temporal chronological relationship is described with phrases such as “after,” “following,” “next to,” “before,” etc., non-continuous cases may be included, unless “immediately” or “directly” is used.

It will be understood that, although the terms “first,” “second,” etc., may be used herein to describe various components, these components should not be limited by these terms. These terms may only be used to distinguish one component from another. Therefore, the “first” component referred to below may also be a “second” component within the technical scope of the present disclosure.

The term “at least one” should be understood to include all possible combinations of one or more related items. For example, “at least one of a first, second, and third items” may mean not only each of the first, second, and third items, but also any combination of items that can be represented by two or more of the first, second, and third items.

The features of each of various embodiments of the present disclosure can be partially or entirely combined or may be combined with each other, and various technical connections and operations are possible, and each embodiment can be implemented independently of each other or implemented together in a relationship therebetween.

Hereinafter, embodiments of this specification will be described in detail with reference to the accompanying drawings.

FIG. 1 illustrates a display apparatus according to a related art.

As illustrated in FIG. 1, the display apparatus according to the related art includes a control-printed circuit board (C-PCB) 100, source-printed circuit boards (S-PCBs) 110, and flexible flat cables (FFCs) 120 that connect the C-PCB 100 and S-PCBs 110 described above.

In addition, although not illustrated in FIG. 1, the C-PCB 100 is equipped with a NAND flash memory or the like, which is an example of a non-volatile memory that stores compensation data of a panel related to organic light-emitting diodes (OLEDs) or the like.

However, as described above, when the NAND flash memory that stores the compensation data of the panel is mounted on the C-PCB 100, there is a problem that the maintenance/repair costs of the OLED panel increase.

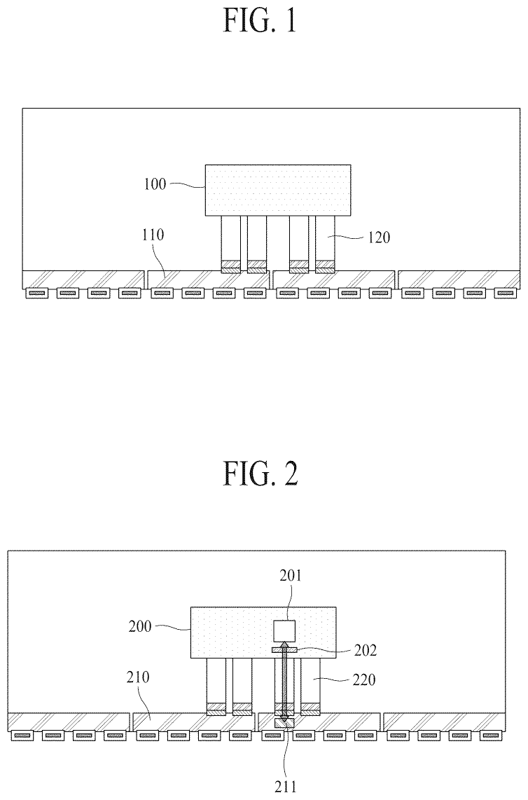

In order to solve this problem, it is necessary to install a non-volatile memory that stores compensation data of a panel related to OLEDs or the like on another board, and an embodiment related to this will be described below with reference to FIG. 2.

FIG. 2 illustrates a display apparatus according to an embodiment of the present disclosure.

As illustrated in FIG. 2, the display apparatus according to the embodiment of the present disclosure includes a C-PCB 200, S-PCBs 210, and FFCs 220 that connect the C-PCB 200 and S-PCBs 210 described above.

However, unlike those in FIG. 1, a NAND flash memory 211, which is an example of a non-volatile memory that stores panel compensation data, is designed to be mounted on the S-PCB 210 rather than the C-PCB 200.

In addition, an application-specific integrated circuit (ASIC) 201 mounted on the C-PCB 200 may read and write the panel compensation data using the NAND flash memory 211.

When designed as illustrated in FIG. 2, there is an advantage in that replacement/repair/maintenance costs of OLED panels, boards, or the like may be reduced.

However, there is a problem that electromagnetic interference (EMI) increases when the panel compensation data is stored in the NAND flash memory 211, for example, every 30 minutes.

In this case, when the length of the FFC 220 is 155 mm, the EMI issue may be resolved to some extent by adding an RC filter 202 (e.g., 22Ω+33 pF).

On the other hand, when the length of the FFC 220 is 350 mm, there is a limitation in that the EMI issue cannot be resolved with the RC filter 202 described above.

In addition, when an embedded multimedia card (eMMC) is applied instead of the NAND flash memory 211, not only is the length of the FFC 220 limited due to, for example, 1.8 V input/output (IO) signal transmission, but signal distortion and loss are also large, and thus there is a limitation in that it is difficult to apply the eMMC instead of the NAND flash memory 211.

Even when the NAND flash memory 211 is continuously used, there is a limitation in that it is difficult to apply the FFC 220 of 500 mm or more in length and a data transmission speed is limited.

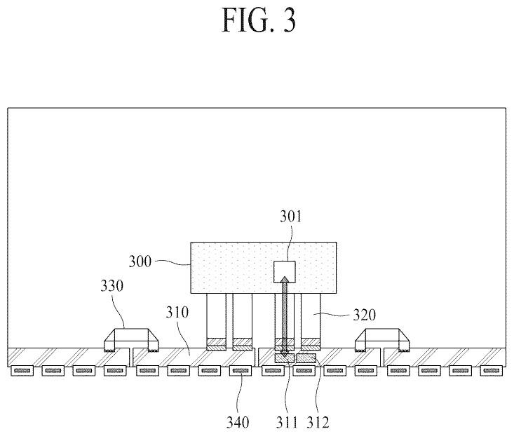

That is, an embodiment for resolving the above-described limitations that occur when the memory that stores the panel compensation data is mounted on the S-PCB will be described below with reference to FIG. 3 in more detail.

FIG. 3 illustrates a display apparatus according to another embodiment of the present disclosure.

The display apparatus illustrated in FIG. 3 (e.g., which may include an OLED panel, but the present disclosure is not limited thereto) includes a first substrate 300 and second substrates 310.

Here, the first substrate 300 corresponds to, for example, the C-PCB described above, and the second substrate 310 corresponds to, for example, the S-PCB described above.

A first module 301 in the first substrate 300 generates a packet related to panel compensation data and transmits the generated packet. The first module 301 corresponds to, for example, an ASIC. Furthermore, the first module 301 may correspond to a timing controller (T-CON).

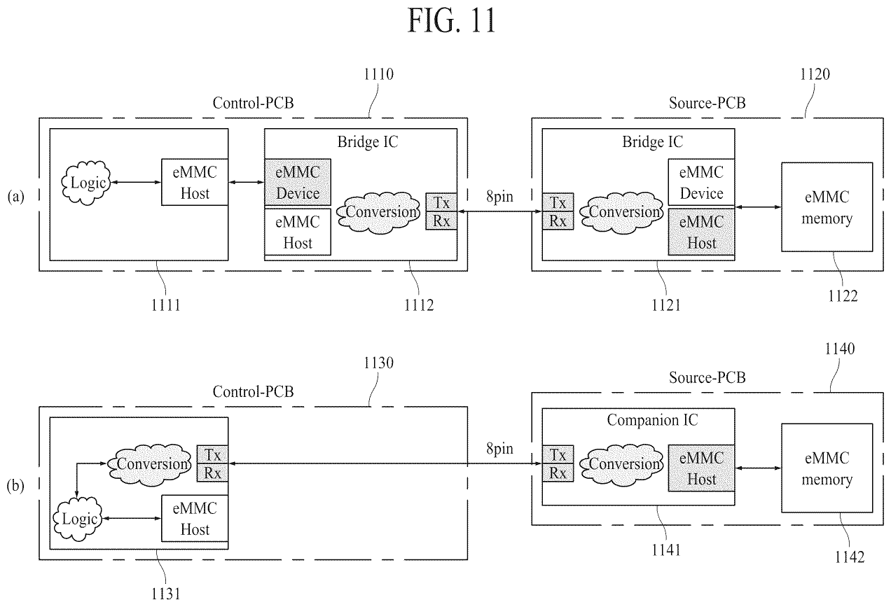

A second module 311 in the second substrate 310 receives the packet related to the panel compensation data, then decodes the received packet, and transmits the packet related to the panel compensation data to a memory 312 only when it is determined that the packet is valid by referring to a specific field included in the packet. The second module 311 may be referred to, for example, as a companion chip or a bridge integrated circuit (IC). An embodiment related to this will be described below with reference to FIG. 11 in more detail.

The memory 312 corresponds to, for example, a NAND flash memory or an eMMC.

The first substrate 300 and the second substrate 310 are connected by a first type FFC 320, and the second substrate 310 and another second substrate are connected by a second type FFC 330.

In addition, each of a plurality of second substrates 310 are connected to a plurality of source driver ICs (SDICs) 340. In FIG. 3, four SDICs 340 are illustrated as being electrically connected to one second substrate 310, but the present disclosure is not limited thereto.

In a write mode, the first module 301 in the first substrate 300 receives at least one done command from the memory 312 via the second module 311 in the second substrate 310.

On the other hand, in a read mode, the first module 301 in the first substrate 300 is designed to receive the panel compensation data stored in the memory 312 via the second module 311 in the second substrate 310 and to correct image data on the basis of the received panel compensation data. Due to the nature of OLEDs, a technology for correcting image data using panel compensation data is important.

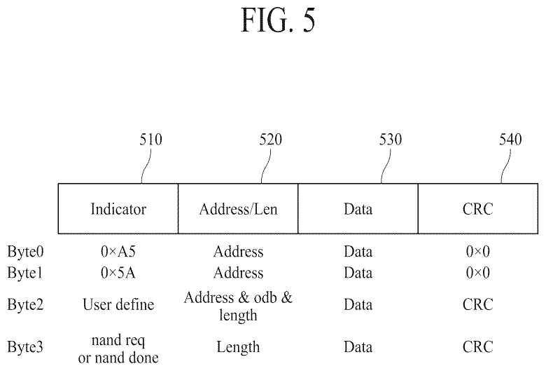

Meanwhile, the packet related to the panel compensation data that is transmitted or received by the first module 301 in the first substrate 300 and the second module 311 in the second substrate 310 includes a first field for synchronizing a packet start point when data is transmitted and defining attribute information of data to be transmitted, a second field for defining address and length information of the data to be transmitted, a third field for defining actual data included in the packet, and a fourth field that is used for validity verification of the packet. In particular, the specific field described above corresponds to the fourth field. An embodiment related to this will be described below with reference to FIG. 5 in more detail.

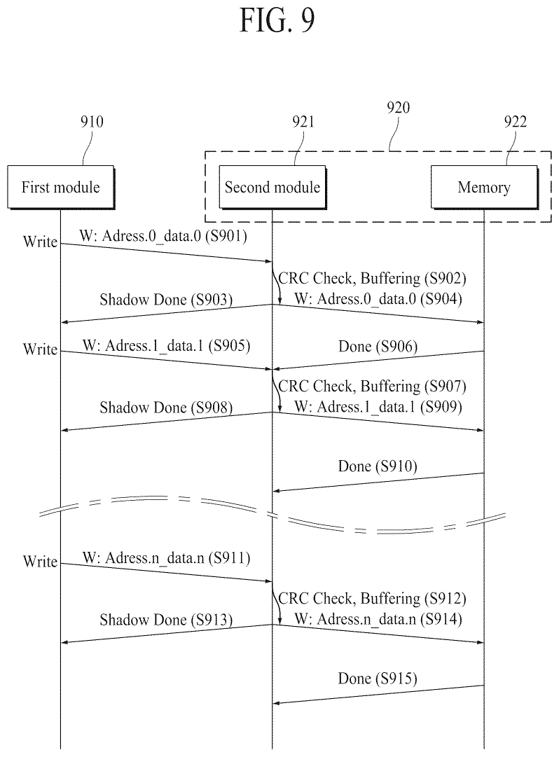

The second module 311 in the second substrate 310 receives the packet related to the panel compensation data, then decodes the received packet, and only when it is determined that the packet is valid by referring to the specific field included in the packet, transmits the packet related to the panel compensation data to the memory 312, and at the same time, transmits a shadow done command to the first module 301. In addition, when receiving the shadow done command, the first module 301 transmits another packet related to the panel compensation data to the second module 311. An embodiment related to this will be described below with reference to FIG. 9 in more detail.

When differential transmission is used between the first module 301 in the first substrate 300 and the second module 311 in the second substrate 310, there is a technical effect of reducing EMI, which was a problem in the related art.

In addition, there is an advantage in that the length of the FFC 320 may extend up to 1,000 mm and when implementing the memory 312, it may be applied not only to a NAND flash memory but also to an eMMC.

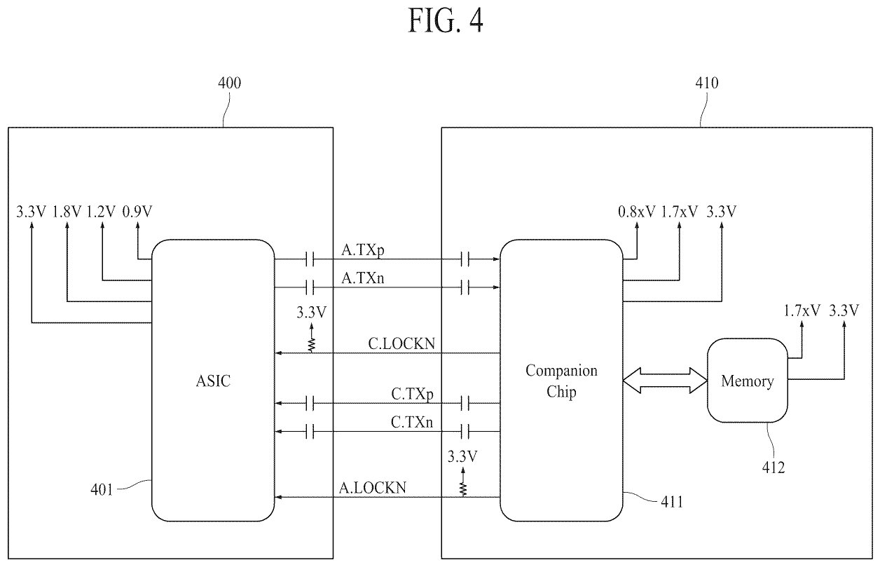

Meanwhile, an example of transmitting or receiving data between the first module 301 in the first substrate 300 and the second module 311 in the second substrate 310 will be described below with reference to FIG. 4.

FIG. 4 illustrates a communication protocol between the first module in the first substrate and the second module in the second substrate illustrated in FIG. 3 in more detail.

An ASIC 401 mounted on a first substrate 400 corresponds to, for example, the first module 301 illustrated in FIG. 3.

A companion chip 411 mounted on a second substrate 410 corresponds to, for example, the second module 311 illustrated in FIG. 3.

A memory 412 mounted on the second substrate 410 corresponds to, for example, the memory 312 illustrated in FIG. 3.

For example, for data communication through a V-by-One interface, in addition to main links (e.g., A.TXp, A.TXn, C.TXp, C.TXn, etc., illustrated in FIG. 4) through which data is transmitted between the first module 401 and the second module 411, there should be auxiliary signal links such as LOCKN (e.g., C.LOCKN, A.LOCKN, etc., illustrated in FIG. 4).

Meanwhile, a data packet that is used to transmit or receive panel compensation data between the ASIC 401, which is an example of the first module illustrated in FIG. 4, and the companion chip 411, which is an example of the second module, will be described below with reference to FIG. 5.

FIG. 5 illustrates an example of a data packet used during a communication process between the first module and the second module illustrated in FIG. 4.

A packet related to panel compensation data defined by an embodiment of the present disclosure includes the fields illustrated in FIG. 5.

A first field 510 (Indicator) is for synchronizing a packet start point during data transmission and defining attribute information of data to be transmitted. Meanwhile, in FIG. 5, “nand req” and “nand done” are exemplified as information included in the first field 510, but this assumes that a NAND memory is used as a storage medium, and the present disclosure may be applied to various storage media, such as an eMMC and the like.

A second field 520 (Address/Len) is for defining address and length information of the data to be transmitted and the like.

A third field 530 (Data) is for defining actual data included in the packet.

In addition, a fourth field 540 (cyclic redundancy check (CRC)) is designed to be used for validity verification of the packet.

In particular, the specific field described in this specification corresponds to the fourth field 540 described above, and the fourth field 540 is used to verify whether the packet related to the panel compensation data is valid. According to the related art, when image display data is transmitted or received, CRC information is not used.

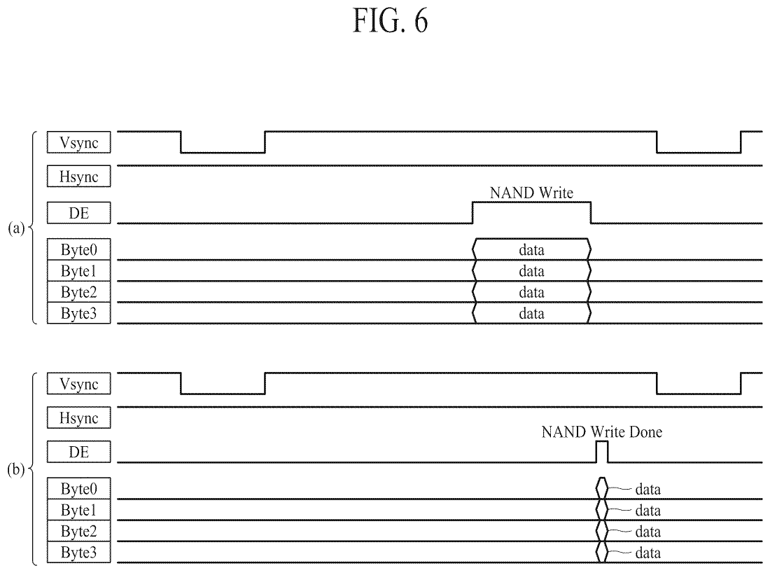

FIG. 6 shows diagrams for describing timing when the data packet illustrated in FIG. 5 is used. In FIG. 6, although a data format flow is assumed when Vx1 is used, the present disclosure is not limited thereto.

Furthermore, in FIG. 6, “NAND Write” and “NAND Write Done” are exemplified, but this only assumes that a NAND memory is used as a storage medium, and the present disclosure may be applied to various storage media such as an eMMC and the like.

FIG. 6A illustrates the flow of the data format output by an ASIC, which is an example of a first module in a first substrate, while FIG. 6B illustrates the flow of the data format output by a companion chip, which is an example of a second module in a second substrate.

A DE signal illustrated in FIG. 6 is a signal that indicates an actual input section in which image data is input after Hsync is input.

However, as illustrated in FIG. 6A, when the DE signal changes from a low state to a high state, the ASIC, which is an example of the first module in the first substrate, outputs panel compensation data.

On the other hand, as illustrated in FIG. 6B, when the DE signal changes from a low state to a high state, the companion chip, which is an example of the second module in the second substrate, outputs done data indicating that the panel compensation data has been written to a memory.

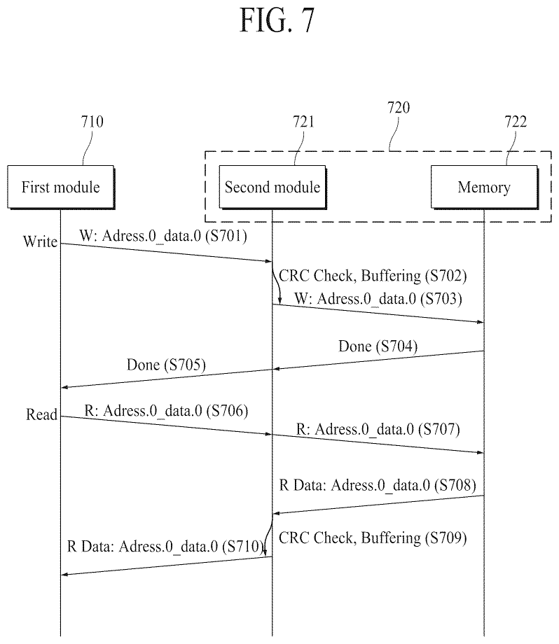

FIG. 7 schematically illustrates a write mode and read mode of a display apparatus according to an embodiment of the present disclosure.

First, a process in which the display apparatus according to the embodiment of the present disclosure executes a write mode of panel compensation data using internal communication will be described.

A first module 710 in a first substrate transmits address information Address.0 and actual data data.0 for writing the panel compensation data to a second module 721 in a second substrate 720 (S701).

The second module 721 in the second substrate 720 checks the CRC and the like illustrated in FIG. 5 to check whether there is no error in a packet (related to the panel compensation data) received from the first module 710 (S702).

As a result of the check (in S702), when it is checked that there is no error in the packet related to the panel compensation data, the second module 721 transmits the address information Address.0 and actual data data.0 for writing the panel compensation data to a memory 722 in the second substrate 720 (S703).

When the memory 722 stores the panel compensation data, a procedure done message is transmitted to the second module 721 (S704), and the second module 721 also transmits a procedure done message to the first module 710 (S705).

Next, a process in which the display apparatus according to the embodiment of the present disclosure executes a read mode of the panel compensation data using internal communication will be described.

The first module 710 in the first substrate transmits address information Address.0 and actual data data.0 for reading the panel compensation data to the second module 721 in the second substrate 720 (S706).

The second module 721 transmits the address information Address.0 and actual data data.0 for reading the panel compensation data to the memory 722 in the second substrate 720 (S707).

The memory 722 transmits actual panel compensation data R_Data to the second module 721, and the second module 721 checks the CRC and the like illustrated in FIG. 5 to check whether there is no error in a packet (related to the panel compensation data) received from the memory 722 (S709).

As a result of the check (in S709), when it is checked that there is no error in the packet related to the panel compensation data, the second module 721 transmits the panel compensation data R Data to the first module 710 (S710).

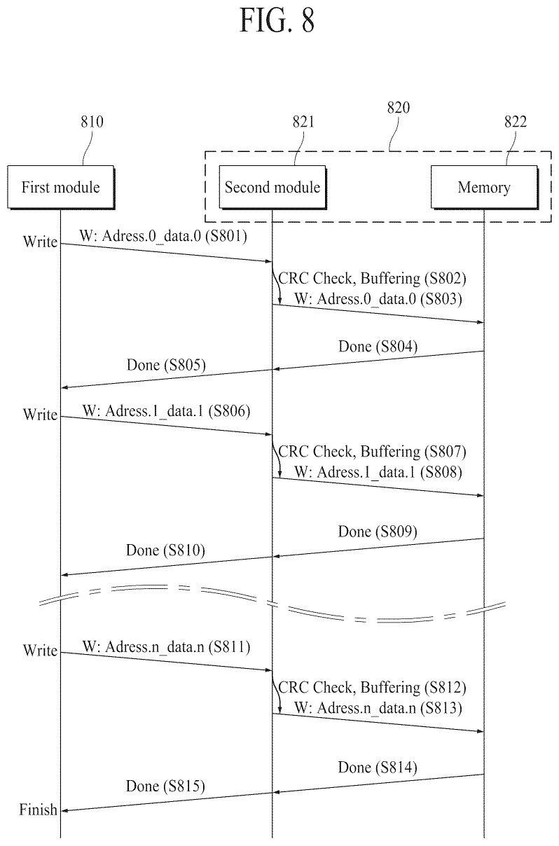

Operations S701 to S705 corresponding to the write mode illustrated in FIG. 7 will be described below with reference to FIG. 8 in more detail.

FIG. 8 is a flowchart illustrating the write mode illustrated in FIG. 7 in more detail.

A first module 810 in a first substrate transmits address information Address.0 and actual data data.0 for writing panel compensation data to a second module 821 in a second substrate 820 (S801).

The second module 821 in the second substrate 820 checks the CRC and the like illustrated in FIG. 5 to check whether there is no error in a packet (related to the panel compensation data) received from the first module 810 (S802).

As a result of the check (in S802), when it is checked that there is no error in the packet related to the panel compensation data, the second module 821 transmits the address information Address.0 and actual data data.0 for writing the panel compensation data to a memory 822 in the second substrate 820 (S803).

When the memory 822 stores the panel compensation data, a procedure done message is transmitted to the second module 821 (S804), and the second module 821 also transmits a procedure done message to the first module 810 (S805).

When there are a plurality of pieces of panel compensation data, the above-described process is designed to be repeated.

The first module 810 in the first substrate transmits address information Address.1 and actual data data.1 for writing the panel compensation data to the second module 821 in the second substrate 820 (S806).

The second module 821 in the second substrate 820 checks the CRC and the like illustrated in FIG. 5 to check whether there is no error in a packet (related to the panel compensation data) received from the first module 810 (S807).

As a result of the check (in S807), when it is checked that there is no error in the packet related to the panel compensation data, the second module 821 transmits the address information Address.1 and actual data data.1 for writing the panel compensation data to the memory 822 in the second substrate 820 (S808).

When the memory 822 stores the panel compensation data, a procedure done message is transmitted to the second module 821 (S809), and the second module 821 also transmits a procedure done message to the first module 810 (S810).

Assuming that there are n pieces of panel compensation data to be written to a memory in a write mode, the above-described process is designed to be repeated n times.

The first module 810 in the first substrate transmits address information Address.n and actual data data.n for writing the panel compensation data to the second module 821 in the second substrate 820 (S811).

The second module 821 in the second substrate 820 checks the CRC and the like illustrated in FIG. 5 to check whether there is no error in a packet (related to the panel compensation data) received from the first module 810 (S812).

As a result of the check (in S812), when it is checked that there is no error in the packet related to the panel compensation data, the second module 821 transmits the address information Address.n and actual data data.n for writing the panel compensation data to the memory 822 in the second substrate 820 (S813).

When the memory 822 stores the panel compensation data, a procedure done message is transmitted to the second module 821 (S814), and the second module 821 also transmits a procedure done message to the first module 810 (S815).

However, when designed as illustrated in FIG. 8, there is a limitation in that the write mode takes excessively long period of time as the amount of panel compensation data to be written to the memory increases. In order to address this problem, in an embodiment of the present disclosure, a shadow done message is introduced, and an embodiment related to this will be described below with reference to FIG. 9.

FIG. 9 is a flowchart for further improving a processing speed in the write mode illustrated in FIG. 8.

A first module 910 in a first substrate transmits address information Address.0 and actual data data.0 for writing panel compensation data to a second module 921 in a second substrate 920 (S901).

The second module 921 in the second substrate 920 checks the CRC and the like illustrated in FIG. 5 to check whether there is no error in a packet (related to the panel compensation data) received from the first module 910 (S902).

As a result of the check (in S902), when it is checked that there is no error in the packet related to the panel compensation data, the second module 921 transmits the address information Address.0 and actual data data.0 for writing the panel compensation data to a memory 922 in the second substrate 920 (S904).

Furthermore, unlike the embodiment illustrated in FIG. 8, in FIG. 9, the second module 921 transmits a shadow done message to the first module 910 (S903). This operation may be performed simultaneously with operation S904.

Therefore, there is a technical effect of enabling the first module 910 to transmit a next packet related to the panel compensation data to the second module 921 more rapidly.

When the memory 922 stores the panel compensation data, a procedure done message is transmitted to the second module 921 (S906), but the second module 921 does not need to transmit a procedure done message to the first module 910. This is because a shadow done message has already been transmitted immediately after operation S902 (S903).

The first module 910 in the first substrate transmits address information Address.1 and actual data data.1 for writing the panel compensation data to the second module 921 in the second substrate 920 (S905).

The second module 921 in the second substrate 920 checks the CRC and the like illustrated in FIG. 5 to check whether there is no error in a packet (related to the panel compensation data) received from the first module 910 (S907).

As a result of the check (in S907), when it is checked that there is no error in the packet related to the panel compensation data, the second module 921 transmits the address information Address.1 and actual data data.1 for writing the panel compensation data to the memory 922 in the second substrate 920 (S909).

Furthermore, unlike the embodiment illustrated in FIG. 8, in FIG. 9, the second module 921 transmits a shadow done message to the first module 910 (S908). This operation may be performed simultaneously with operation S909.

When the memory 922 stores the panel compensation data, a procedure done message is transmitted to the second module 921 (S910), but the second module 921 does not need to transmit a procedure done message to the first module 910. This is because a shadow done message has already been transmitted immediately after operation S907 (S908).

The first module 910 in the first substrate transmits address information Address.n and actual data data.n for writing the panel compensation data to the second module 921 in the second substrate 920 (S911).

The second module 921 in the second substrate 920 checks the CRC and the like illustrated in FIG. 5 to check whether there is no error in a packet (related to the panel compensation data) received from the first module 910 (S912).

As a result of the check (in S912), when it is checked that there is no error in the packet related to the panel compensation data, the second module 921 transmits the address information Address.n and actual data data.n for writing the panel compensation data to the memory 922 in the second substrate 920 (S914).

Furthermore, unlike the embodiment illustrated in FIG. 8, in FIG. 9, the second module 921 transmits a shadow done message to the first module 910 (S913). This operation may be performed simultaneously with operation S914.

When the memory 922 stores the panel compensation data, a procedure done message is transmitted to the second module 921 (S915), but the second module 921 does not need to transmit the procedure done message to the first module 910. This is because a shadow done message has already been transmitted immediately after operation S912 (S913).

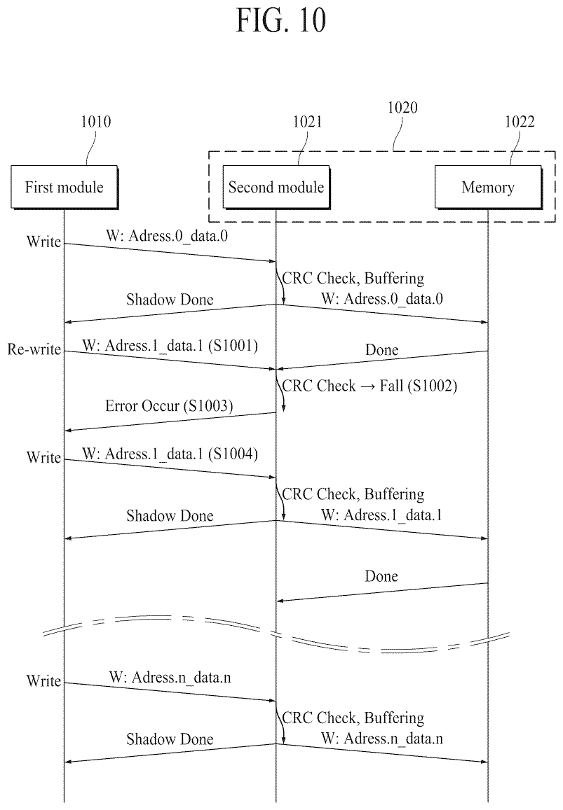

In the embodiments previously illustrated in FIGS. 7 to 9, assuming that there is no problem with the CRC included in the packet related to the panel compensation data, but a solution for resolving a case in which there is an error in the corresponding packet will be described below with reference to FIG. 10.

FIG. 10 is a flowchart of a processing process when there is a problem in CRC information in the write mode illustrated in FIG. 9. Descriptions of operations identical to those in FIGS. 7 to 9 will be omitted.

A first module 1010 in a first substrate transmits address information Address.1 and actual data data.1 for writing panel compensation data to a second module 1021 in a second substrate 1020 (S1001).

The second module 1021 in the second substrate 1020 checks the CRC and the like illustrated in FIG. 5 to check whether there is no error in a packet (related to the panel compensation data) received from the first module 1010 (S1002).

As a result of the check (in S1002), when it is checked that there is an error in the packet related to the panel compensation data, the second module 1021 does not transmit the address information Address.1 and actual data data.1 for writing the panel compensation data to a memory 1022 in the second substrate 1020.

The second module 1021 transmits a message indicating that an error has occurred to the first module 1010 (S1003).

Therefore, the first module 1010 is designed to retransmit the address information Address.1 and actual data data.1 for writing the panel compensation data to the second module 1021 in the second substrate 1020 (S1004).

FIG. 11 illustrates two embodiments a C-PCB and an S-PCB which are included in a display apparatus according to an embodiment of the present disclosure.

Meanwhile, in FIG. 11, an eMMC memory exemplified, but the present disclosure may be equally applied to various storage media such as a NAND memory and the like.

FIG. 11A illustrates an embodiment in which two chips are included in a C-PCB, while FIG. 11B illustrates an embodiment in which one chip is included in a C-PCB.

As illustrated in FIG. 11A, a C-PCB 1110 is implemented using an ASIC 1111 and a bridge IC 1112, and a S-PCB 1120 is implemented using a bridge IC 1121 and an eMMC memory 1122.

FIG. 11A has an advantage of being able to reuse the existing T-CON.

As illustrated in FIG. 11B, a C-PCB 1130 is implemented using a single ASIC 1131, and a S-PCB 1140 is implemented using a companion IC 1141 and an eMMC memory 1142.

FIG. 11B has an advantage of implementing a C-PCB with a single chip to further increase a processing speed thereof.

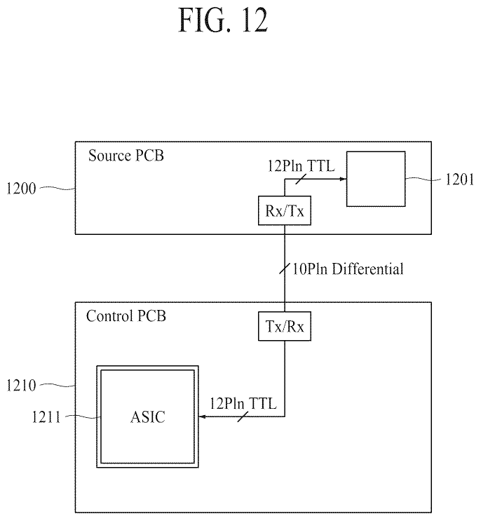

In addition, FIG. 12 illustrates an embodiment different from the embodiments illustrated in FIG. 11.

A memory 1201 that can store panel compensation data is mounted on a S-PCB 1200, and an ASIC 1211 is mounted on a C-PCB 1210.

The memory 1201 is connected to a first transceiver Rx/Tx via a 12-pin transistor-transistor logic (TTL) to communicate with each other, and the ASIC 1211 is connected to a second transceiver Tx/Rx via a 12-pin TTL to communicate with each other. Finally, the first transceiver Rx/Tx and the second transceiver Tx/Rx are designed to perform 10-pin differential communication. However, these numbers are merely exemplary numerical numbers and the present disclosure is not limited thereto.

According to an embodiment of the present disclosure, for example, panel compensation data in a display apparatus such as an OLED display or the like can be stored in a specific board (e.g., a S-PCB or the like), and various problems occurring during a communication process between a S-PCB and a C-PCB can be solved.

More specifically, for example, there is a technical effect of reducing EMI and increasing the length of a flex flat cable (FFC) connecting boards.

Furthermore, by storing panel compensation data in a S-PCB rather than a C-PCB, there is no need to replace the entire board when a panel failure occurs, and thus there is an advantage of reducing maintenance/repair costs of OLEDs.

In addition, it is expected that the technical effect of suggesting a data packet structure, for example, appropriate for the Vx1 standard, is possible to enable long-distance data transmission for a non-volatile memory in a display apparatus.

Meanwhile, in addition to the technical effects explicitly described herein, technical effects that can be inferred by those skilled in the art from the intent of the entire specification also fall within the scope of the present disclosure.

It will be understood by those skilled in the art that various modifications can be made without departing from the scope of the present disclosure and without changing essential features.

Further, the methods described in this specification may be implemented, at least in part, using one or more computer programs or components. The components may be provided as a series of computer instructions through computer-readable media or machine-readable media, including volatile and non-volatile memories. The instructions may be provided as software or firmware and may be implemented in whole or in part in hardware configurations such as ASICs, field-programmable gate arrays (FPGAs), digital signal processors (DSPs), or other similar devices. The instructions may be executed by one or more processors or other hardware components, and the processors or other hardware components, when executing the series of computer instructions, perform all or a part of the methods and procedures disclosed in this specification or enable the methods and procedures to be performed.

Therefore, the above-described embodiments should be considered in a descriptive sense only and not for purposes of limitation. Accordingly, the scope of the present disclosure is not limited by the embodiments. The scope of the present disclosure is defined by the appended claims and encompasses all modifications and equivalents that fall within the scope of the appended claims.

What is claimed is:

1. A method of controlling communication being performed in a display apparatus, the method comprising:
transmitting, by a first module in a first substrate, a packet related to panel compensation data to a second module in a second substrate;
transmitting, by the second module in the second substrate, the packet related to the panel compensation data to a memory in the second substrate only when it is determined that the packet is valid by referring to a specific field included in the packet related to the panel compensation data;
in a write mode, receiving, by the first module in the first substrate, at least one done command from the memory via the second module in the second substrate; and
in a read mode, receiving, by the first module in the first substrate, the panel compensation data stored in the memory via the second module in the second substrate and correcting image data on the basis of the received panel compensation data.

2. The method of claim 1, wherein the packet related to the panel compensation data includes:
a first field for synchronizing a packet start point when data is transmitted and defining attribute information of data to be transmitted;
a second field for defining address and length information of the data to be transmitted;
a third field for defining actual data included in the packet; and
a fourth field used for validity verification of the packet, and
the specific field corresponds to the fourth field.

3. The method of claim 1, wherein the transmitting of, by the second module in the second substrate, the packet related to the panel compensation data to the memory in the second substrate only when it is determined that the packet is valid by referring to the specific field included in the packet related to the panel compensation data further includes transmitting, by the second module, a shadow done command to the first module simultaneously with the transmitting of the packet related to the panel compensation data to the memory in the second substrate.

4. The method of claim 3, further comprising transmitting, by the first module that receives the shadow done command, another packet related to the panel compensation data to the second module.

5. The method of claim 1, wherein the memory corresponds to a NAND flash memory or an embedded multimedia card (eMMC).

6. The method of claim 1, wherein the first substrate and the second substrate are connected by a first type flexible flat cable (FFC), and
the second substrate and another second substrate are connected by a second type FFC.

7. A display apparatus comprising:
a first module in a first substrate that generates a packet related to panel compensation data and transmits the generated packet; and
a second module in a second substrate that receives the packet related to the panel compensation data, then decodes the received packet, and transmits the packet related to the panel compensation data to a memory only when it is determined that the packet is valid by referring to a specific field included in the packet,
wherein, in a write mode, the first module in the first substrate receives at least one done command from the memory via the second module in the second substrate, and
in a read mode, the first module in the first substrate receives the panel compensation data stored in the memory via the second module in the second substrate and corrects image data on the basis of the received panel compensation data.

8. The display apparatus of claim 7, wherein the memory corresponds to a NAND flash memory or an embedded multimedia card (eMMC).

9. The display apparatus of claim 7, wherein the first substrate and the second substrate are connected by a first type flexible flat cable (FFC), and
the second substrate and another second substrate are connected by a second type FFC.

10. The display apparatus of claim 7, wherein the packet related to the panel compensation data includes:
a first field for synchronizing a packet start point when data is transmitted and defining attribute information of data to be transmitted;
a second field for defining address and length information of the data to be transmitted;
a third field for defining actual data included in the packet; and
a fourth field used for validity verification of the packet, and
the specific field corresponds to the fourth field.

11. The display apparatus of claim 7, wherein the second module in the second substrate receives the packet related to the panel compensation data, then decodes the received packet, and only when it is determined that the packet is valid by referring to a specific field included in the packet, transmits the packet related to the panel compensation data to the memory, and at the same time, transmits a shadow done command to the first module.

12. The display apparatus of claim 11, wherein, upon receiving the shadow done command, the first module transmits another packet related to the panel compensation data to the second module.
